(19) United States
(12) Patent Application Publication
(10) Pub. No.: US 2021/0311799 A1
(43) Pub. Date: Oct. 7, 2021

(54) WORKLOAD ALLOCATION AMONG HARDWARE DEVICES

(71) Applicant: Micron Technology, Inc., Boise, ID (US)

(72) Inventors: Allan Porterfield, Durham, NC (US); Vijay S. Ramesh, Boise, ID (US)

(21) Appl. No.: 16/838,272

(22) Filed: Apr. 2, 2020

(51) Int. Cl. G06F 9/50; G06N 20/00; G06F 9/48

(52) U.S. Cl. CPC G06F 9/5044; G06F 9/505; G06F 9/4881; G06N 20/00

(57) ABSTRACT

An example method corresponding to workload allocation among hardware devices can include monitoring, by a processing unit, workload characteristics associated with execution of workloads by a plurality of hardware devices, such as hardware accelerators. The method can include determining, by the processing unit, particular characteristics corresponding to a workload processed by at least one of the hardware devices and performing, by the processing unit, an action to determine that a particular hardware device exhibits higher performance in executing the workload than a different hardware device. The method can further include allocating a subsequent workload that has characteristics corresponding to the workload exhibiting the particular characteristics to the hardware device that exhibits higher performance in executing the workload than a different hardware device.

### TECHNICAL FIELD

The present disclosure relates generally to semiconductor memory and methods, and more particularly, to apparatuses, systems, and methods for workload allocation among hardware devices.

### BACKGROUND

Hardware acceleration can be implemented in computing systems to perform certain tasks and/or functions in a manner that is more efficient (e.g., faster, more accurate, higher quality, etc.) in comparison to performing the task and/or function using a central processing unit (CPU) of the computing system. For example, by providing dedicated hardware (e.g., a hardware accelerator or hardware acceleration unit) that is configured to perform a certain task and/or function that can otherwise be performed using the CPU of the computing system, certain tasks and/or functions can be processed in a more efficient manner than in approaches in which the CPU is responsible for performance of such tasks and/or functions. This can further allow for processing resources that could otherwise be consumed by the CPU to be freed up, thereby further improving performance of the computing system.

### BRIEF DESCRIPTION OF THE DRAWINGS

FIG. 1 is a functional block diagram in the form of a computing system including a controller and a plurality of hardware devices in accordance with a number of embodiments of the present disclosure.

FIG. 2 is a functional block diagram in the form of a computing system including a controller, a plurality of processing units, and a plurality of hardware devices in accordance with a number of embodiments of the present disclosure.

FIG. 3 is a functional block diagram in the form of a computing system including a processing unit, a controller, and hardware devices in accordance with a number of embodiments of the present disclosure.

FIG. 4 is a flow diagram representing an example method corresponding to workload allocation among hardware devices in accordance with a number of embodiments of the present disclosure.

### DETAILED DESCRIPTION

Systems, apparatuses, and methods related to workload allocation among hardware devices. An example method corresponding to workload allocation among hardware devices can include monitoring, by a processing unit, workload characteristics associated with execution of workloads by a plurality of hardware devices, such as hardware accelerators. The method can include determining, by the processing unit, particular characteristics corresponding to a workload processed by at least one of the hardware devices and performing, by the processing unit, an action to determine that a particular hardware device exhibits higher performance in executing the workload than a different hardware device. The method can further include allocating a subsequent workload that has characteristics corresponding to the workload exhibiting the particular characteristics to the hardware device that exhibits higher performance in executing the workload than a different hardware device.

Hardware acceleration can be implemented using hardware devices (e.g., hardware accelerators, arithmetic logic units, neuromorphic processors, cryptographic accelerator units, etc.) in computing systems to perform certain tasks and/or functions in a manner that is more efficient (e.g., faster, more accurate, higher quality, etc.) in comparison to performing the task and/or function using a central processing unit (CPU) of the computing system. For example, by providing dedicated hardware (e.g., a hardware accelerator or hardware acceleration unit) that is configured to perform a certain task and/or function that can otherwise be performed using the CPU of the computing system, certain tasks and/or functions can be processed in a more efficient manner than in approaches in which the CPU is responsible for performance of such tasks and/or functions. This can further allow for processing resources that could otherwise be consumed by the CPU to be freed up, thereby further improving performance of the computing system.

Some examples of hardware accelerators include sounds processing units (e.g., sound cards), graphics processing units (GPUs or “graphics cards”), digital signal processing units, analog signal processing units, computer networking processing units (e.g., networks on a chip, TCP offload engines, I/O acceleration processing units, etc.), cryptography processing units (e.g., cryptographic accelerator units, which can provide hardware-based encryption and/or decryption), artificial intelligence processing units (e.g., vision processing units, neural network processing units, etc.), tensor processing units, physics processing units, regular expression processing units, and/or data compression acceleration units, among others. Hardware accelerators can be provided as computer hardware in the form of a field-programmable gate array (FPGA), an application-specific integrated circuit (ASIC), and/or a complex programmable logic device, a system-on-chip, among others. It will be appreciated that the foregoing enumerated examples of hardware accelerators and specifically enumerated examples of computer hardware are neither limiting nor exhaustive, and other hardware accelerators and/or computer hardware are contemplated within the scope of the disclosure.

In some approaches, hardware accelerators can be deployed in a computing system as discrete components that perform a specified task and/or function with no visibility to other hardware accelerators that can be deployed within the computing system. For example, in some approaches, a hardware accelerator can operate without knowledge of other hardware accelerators deployed within the computing system. Further, in some approaches, hardware accelerators can be dedicated to perform a limited set of specific tasks and/or functions. For example, a sound processing unit can be provided in a computing system with the purpose of performing hardware acceleration on signals related to auditory playback for the computing system. As another example, a GPU can be provided in a computing system for the purpose of performing hardware acceleration on signals related to visual display for the computing system.

However, as the quantity of hardware accelerators in a computing system increases and/or as the tasks and/or functions allocated to hardware devices (e.g., hardware accelerators) become increasingly disparate, it can be beneficial to allow communication between the hardware accelerators and/or a processing unit that is configured to orchestrate performance of the tasks and/or functions performed by the hardware accelerators. This can allow for improved computing system performance because, in contrast to approaches that do not allow for communication between hardware devices, such as hardware accelerators, tasks and/or functions (e.g., workloads) can be allocated to optimize performance of the computing system in embodiments described herein.

In addition, in scenarios where multiple hardware accelerators that perform same or similar tasks are utilized in a computing system, certain hardware accelerators may perform certain tasks or functions better (e.g., faster, using less processing resources, etc.) than other hardware accelerators. For example, if multiple arithmetic logic units (ALUs) are deployed in a computing system, some of the ALUs may perform certain tasks or functions better than other ALUs. This can be due to manufacturing differences, operating lifespans of the ALUs, and/or specs of the ALUs, among other factors. In order to more efficiently take advantage of these properties, embodiments herein can allow for workload characteristics of hardware accelerators to be monitored. This information can then be used to selectively allocate workloads to hardware accelerators that exhibit workload characteristics that are greater than other hardware accelerators for particular tasks or functions.

In the following detailed description of the present disclosure, reference is made to the accompanying drawings that form a part hereof, and in which is shown by way of illustration how one or more embodiments of the disclosure may be practiced. These embodiments are described in sufficient detail to enable those of ordinary skill in the art to practice the embodiments of this disclosure, and it is to be understood that other embodiments may be utilized and that process, electrical, and structural changes may be made without departing from the scope of the present disclosure.

As used herein, designators such as “X,” “N,” “M,” etc., particularly with respect to reference numerals in the drawings, indicate that a number of the particular feature so designated can be included. It is also to be understood that the terminology used herein is for the purpose of describing particular embodiments only, and is not intended to be limiting. As used herein, the singular forms “a,” “an,” and “the” can include both singular and plural referents, unless the context clearly dictates otherwise. In addition, “a number of,” “at least one,” and “one or more” (e.g., a number of memory banks) can refer to one or more memory banks, whereas a “plurality of” is intended to refer to more than one of such things.

Furthermore, the words “can” and “may” are used throughout this application in a permissive sense (i.e., having the potential to, being able to), not in a mandatory sense (i.e., must). The term “include,” and derivations thereof, means “including, but not limited to.” The terms “coupled” and “coupling” mean to be directly or indirectly connected physically or for access to and movement (transmission) of commands and/or data, as appropriate to the context. The terms “data” and “data values” are used interchangeably herein and can have the same meaning, as appropriate to the context.

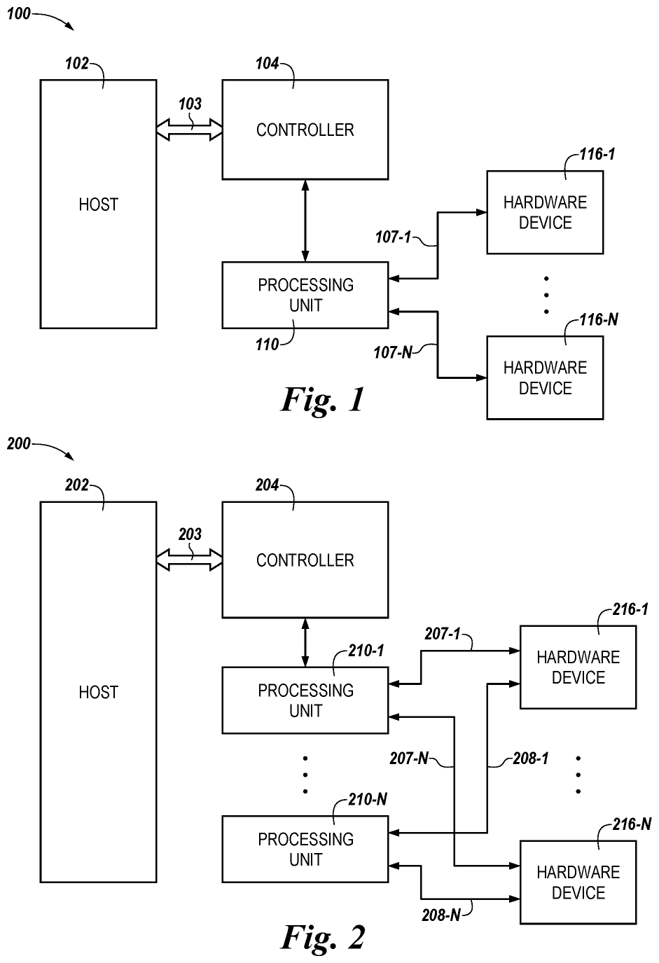

The figures herein follow a numbering convention in which the first digit or digits correspond to the figure number and the remaining digits identify an element or component in the figure. Similar elements or components between different figures may be identified by the use of similar digits. For example, 104 may reference element “04” in FIG. 1, and a similar element may be referenced as 204 in FIG. 2. A group or plurality of similar elements or components may generally be referred to herein with a single element number. For example, a plurality of reference elements 116-1 to 116-N (or, in the alternative, 116-1, . . . , 116-N) may be referred to generally as 116. As will be appreciated, elements shown in the various embodiments herein can be added, exchanged, and/or eliminated so as to provide a number of additional embodiments of the present disclosure. In addition, the proportion and/or the relative scale of the elements provided in the figures are intended to illustrate certain embodiments of the present disclosure and should not be taken in a limiting sense.

FIG. 1 is a functional block diagram in the form of a computing system 100 including a controller 104 and a plurality of hardware devices 116-1 to 116-N in accordance with a number of embodiments of the present disclosure. The host 102, the controller 104, the processing unit 110 can, and/or the hardware devices 116-1 to 116-N can be referred to separately or together as an apparatus. As used herein, an “apparatus” can refer to, but is not limited to, any of a variety of structures or combinations of structures, such as a circuit or circuitry, a die or dice, a module or modules, a device or devices, or a system or systems, for example.

As illustrated in FIG. 1, the hardware devices 116-1 to 116-N can be coupled to a processing unit 110. The processing unit 110 can be any type of processor, combination of co-processors, or the like that can be configured to perform processing operations corresponding to workloads (e.g., tasks and/or functions) performed by the hardware devices 116-1 to 116-N. Non-limiting examples of processing unit 110 can include a full-Linux capable, cache-coherent 64-bit RISC-V processor, a U54-MC computing core, or other processing device configured to perform processing operations corresponding to workloads performed by the hardware devices 116-1 to 116-N. Non-limiting examples of hardware devices 116-1 to 116-N can include hardware accelerators, arithmetic logic units, graphics processing units, cryptographic acceleration units, neuromorphic processors, or other hardware devices that are provided in the computing system 100 to carry out specified workloads for the computing system.

As used herein, the term “workload,” as well as derivatives thereof, refers to an amount of processing allocated to components of a computing system 100 at a given time. With respect to workloads performed by the hardware devices 116, a workload can refer to an amount of processing resources consumed in performance of tasks or functions allocated to the hardware device(s) 116 at a given time. For example, a cryptographic processing workload can be assigned to one or more of the hardware devices 116 and the amount of processing resources allocated by the hardware device(s) 116 to perform the cryptographic processing workload can correspond to the workload itself.

The processing unit 110 can be coupled to a controller 104. The controller 104 can by a non-volatile express (NVMe) media controller that can process command received from the host 102, the hardware devices 116-1 to 116-N, and/or the processing unit 110, although embodiments are not so limited. For example, the controller 104 can be a memory controller that can perform operations to control operations performed by the processing unit 110 and/or the hardware devices 116-1 to 116-N. However, in some embodiments, the controller 104 does not perform processing (e.g., operations to manipulate data) on data processed by the hardware devices 116-1 to 116-N.

The host 102 and/or the controller 104 can be configured to assert a signal and/or a command to the processing unit 110 and/or to the hardware device(s) 116-1 to 116-N to cause the hardware device(s) 116-1 to 116-N to receive workloads and perform tasks and/or functions corresponding to the workloads. When the signal and/or command is asserted to the processing unit 110 and/or to the hardware device(s) 116-1 to 116-N to cause the hardware device(s) 116-1 to 116-N to receive a workload, the hardware devices 116-1 to 116-N can commence performance of tasks and/or functions associated with completing the workload.

In some embodiments, the processing unit 110 can monitor the hardware devices 116-1 to 116-N during performance of the tasks and/or functions associated with completing the workload(s) to determine characteristics corresponding to execution of the workload(s) by the hardware devices 116-1 to 116-N. The characteristics can include quantifiable attributes corresponding to execution of the workloads by the hardware devices 116-1 to 116-N. Some examples of characteristics corresponding to execution of the workloads by the hardware devices 116-1 to 116-N can include an amount of processing resources consumed by the hardware devices 116-1 to 116-N in executing of the workloads, an amount of time taken by the hardware devices 116-1 to 116-N in executing the workloads, thermal properties of the hardware devices 116-1 to 116-N (e.g., an amount of heat increase or decrease exhibited by the hardware devices 116-1 to 116-N) during execution of the workloads, etc.

The processing unit 110 can process information corresponding to the monitored characteristics of the hardware devices 116-1 to 116-N in executing the workloads to rank the hardware devices 116-1 to 116-N based on the monitored characteristics of the hardware devices 116-1 to 116-N in executing the workloads. For example, if two hardware devices 116-1 and 116-N are each allocated a similar workload to execute and one of the hardware devices (e.g., the hardware device 116-1) exhibits higher performance characteristics in executing the workload than the other hardware device (e.g., the hardware device 116-N, the processing unit 110 can rank the first hardware device (116-1) higher than the second hardware device (116-N) with respect to performance of a particular type of workload.

In this manner, the processing unit 110 can be deployed in a testing environment in which multiple hardware devices 116-1 to 116-N execute similar workloads and are ranked based on their characteristics during execution of the workload. In contrast to approaches that assign workloads to hardware devices on an ad hoc basis, embodiments herein can therefore allow for subsequent workloads to be assigned to hardware devices 116-1 to 116-N that exhibit higher performance in executing particular workloads, thereby improving the overall functioning of the computing system 100.

Embodiments are not limited to testing scenarios, however, and in some embodiments, the processing unit 110 can be configured to perform the functions described herein “on the fly” (e.g., during runtime of the computing system 100). For example, the processing unit 110 can be configured to monitor the characteristics of the hardware devices 116-1 to 116-N during execution of workloads at runtime of the computing system 100 and can allocate subsequent workloads to particular hardware devices 116-1 to 116-N based on the monitored characteristics of the hardware devices 116-1 to 116-N in executing particular workloads.

In some embodiments, the processing unit 110 (or the host 102 or the controller 104) can be configured to send commands to synchronize performance of operations performed by the hardware devices 116-1 to 116-N. For example, the processing unit 110 can assert a signal and/or a command to a first hardware device 116-1 to cause the first hardware device 116-1 to perform a first operation, and the processing unit 110 (or the host 102) can assert a signal and/or a command to a second hardware device 116-N to perform a second operation. In some embodiments, the first and/or second operation can include execution of workloads by the hardware devices 116-1 to 116-N. Synchronization of performance of such operations performed by the hardware devices 116-1 to 116-N can include receipt of signals and/or commands to cause the operations to be performed at particular time or in a particular order.

In some embodiments, the processing unit 110 can be configured to assert signals and/or commands to the hardware devices 116-1 to 116-N to cause the hardware devices 116-1 to 116-N to perform the operations in the absence of an intervening signal from the host 102. For example, the processing unit 110 can be configured to monitor performance characteristics of the hardware devices 116-1 to 116-N during execution of the workload(s) and/or allocate workload(s) amongst the hardware devices 116-1 to 116-N without requiring additional signaling or an additional command from the host 102. As a result, a quantity of signals and/or commands utilized in performing the operations can be reduced in comparison to approaches in which the host 102 generates signals and/or commands to facilitate each constituent operation of the processing unit 110 and/or the hardware devices 116-1 to 116-N.

In a non-limiting example, the processing unit 110 is coupleable to a plurality of hardware devices 116-1 to 116-N, as shown in FIG. 1. The processing unit 110 can be configured to receive information indicative of at least one processing characteristic of one or more of the plurality of hardware devices 116-1 to 116-N. The processing unit 110 can be configured to process the information indicative of the at least one processing characteristic to determine a performance characteristic of the one or more hardware devices 116-1 to 116-N and allocate a workload to the one or more hardware devices 116-1 to 116-N based, at least in part, on the determined performance characteristic of the one or more hardware devices 116-1 to 116-N. In some embodiments, the at least one processing characteristic can include information corresponding to a processing performance (e.g., an amount of processing resources consumed, an amount of time consumed, etc.) exhibited by the one or more of the plurality of hardware devices 116-1 to 116-N in processing a particular type of workload. The workload can, as described in more detail herein, be performed as part of a machine learning operation.

The processing unit 110 can be configured to generate a ranking of the plurality of hardware devices 116-1 to 116-N based on the determined performance characteristic of the one or more hardware devices 116-1 to 116-N and allocate the workload to the one or more hardware devices 116-1 to 116-N based, at least in part, on the generated ranking of the plurality of hardware devices 116-1 to 116-N.

The processing unit 110 can be configured to send a command generated based on the determined performance characteristic of the one or more hardware devices 116-1 to 116-N to cause the one or more hardware devices 116-1 to 116-N to distribute the allocated workload amongst the one or more hardware devices 116-1 to 116-N.

In some embodiments, the one or more hardware devices 116-1 to 116-N to which the workload is allocated is configured to allocate a portion of the workload to a hardware device 116-1 to 116-N that is different than the one or more hardware devices 116-1 to 116-N to which the workload is allocated. That is, in some embodiments, one or more of the hardware devices 116-1 to 116-N can be configured to re-allocate execution of a workload (or portion of a workload) amongst the other hardware devices 116-1 to 116-N in the absence of additional signals and/or commands from the processing unit 110. For example, if a particular hardware device (e.g., the hardware device 116-1) does not have enough processing resources available to execute the allocated workload, the hardware device 116-1 can re-allocate the workload (or a portion thereof) to a different hardware device (e.g., the hardware device 116-N) to execute the workload. In this manner, the hardware devices 116-1 to 116-N can communicate with one another to facilitate execution of workload(s) allocated thereto.

The host 102 can be a host system such as a personal laptop computer, a desktop computer, a digital camera, a smart phone, a memory card reader, and/or internet-of-things enabled device, among various other types of hosts, and can include a memory access device, (e.g., a processor or processing device). One of ordinary skill in the art will appreciate that “a processor” can intend one or more processors, such as a parallel processing system, a number of coprocessors, etc. The host 102 can include a system motherboard and/or backplane and can include a number of processing resources (e.g., one or more processors, microprocessors, or some other type of controlling circuitry). In some embodiments, the host can include a host controller, which can be configured to control at least some operations of the host 102 by, for example, generating and transferring commands to the host controller to cause performance of operations such as extended memory operations. The host controller can include circuitry (e.g., hardware) that can be configured to control at least some operations of the host 102. For example, the host controller can be an application specific integrated circuit (ASIC), a field programmable gate array (FPGA), or other combination of circuitry and/or logic configured to control at least some operations of the host 102.

The host 102 can be coupleable to the controller 104 via an interface 103. The interface 103 can include a communication subsystem (e.g., a XBAR, or other communication subsystem configured to transfer data and/or commands between the host 102 and the controller 104), a peripheral component interconnect express (PCIe) buses, double data rate (DDR) interface, interconnect interface (such as AXI interconnect interface), multiplexers (muxes), or other suitable interface or bus. Embodiments are not so limited, however.

The system 100 can include separate integrated circuits or the host 102, the controller 104, the processing unit 110, and/or the hardware devices 116-1 to 116-N can be on the same integrated circuit. The system 100 can be, for instance, a server system and/or a high performance computing (HPC) system and/or a portion thereof. Although the example shown in FIG. 1 illustrate a system having a Von Neumann architecture, embodiments of the present disclosure can be implemented in non-Von Neumann architectures, which may not include one or more components (e.g., CPU, ALU, etc.) often associated with a Von Neumann architecture. The embodiment of FIG. 1 can include additional circuitry that is not illustrated so as not to obscure embodiments of the present disclosure.

FIG. 2 is a functional block diagram in the form of a computing system 200 including a controller 204, a plurality of processing units 210-1 to 210-N, and a plurality of hardware devices 216-1 to 216-N in accordance with a number of embodiments of the present disclosure. The host 202, the controller 204, the hardware device(s) 216, and/or the processing unit(s) 210 can be referred to separately or together as an apparatus. As used herein, an “apparatus” can refer to, but is not limited to, any of a variety of structures or combinations of structures, such as a circuit or circuitry, a die or dice, a module or modules, a device or devices, or a system or systems, for example.

The host 202, controller 204, the hardware devices 216-1 to 216-N, and/or the processing units 210-1 to 210-N can be analogous to the host 102, storage/memory controller 104, the hardware devices 116-1 to 116-N, and/or the processing units 110-1 to 110-N illustrated and described above in connection with FIG. 1. As shown in FIG. 2, the controller 204 can be coupled to the host 202 via an interface 203, which can be analogous to the interface 103 illustrated in FIG. 1. Further, the processing units 210-1 to 210-N can be coupled to the hardware devices 216-1 to 216-N via respective communication paths 207-1 to 207-N and 208-1 to 208-N, which can be analogous to the communication paths 107-1 to 107-N illustrated in FIG. 1.

In contrast to the embodiments depicted in FIG. 1, the embodiments shown in FIG. 2 include multiple processing units 210-1 to 210-N. The processing units 210-1 to 210-N can be coupled together via one or more interfaces. The interfaces can include a communication subsystem (e.g., a XBAR, or other communication subsystem configured to transfer data and/or commands between the processing units 210-1 to 210-N), a peripheral component interconnect express (PCIe) buses, double data rate (DDR) interface, interconnect interface (such as AXI interconnect interface), multiplexers (muxes), or other suitable interface or bus. Embodiments are not so limited, however.

In a non-limiting example, a first hardware device (e.g., the hardware device 216-1) can be communicatively coupled to a second hardware device (e.g., the hardware device 216-N). The first hardware device and the second hardware device can be communicatively coupled to one another via the processing units 210-1 to 210-N, for example, via the communication paths 207-1 to 207-N and/or 208-1 to 208-N, or the first hardware device and the second hardware device can be communicatively coupled directly to one another. The first hardware device 216-1 can be configured to analyze a plurality of workloads processed by the first hardware device 216-1 and/or the second hardware device 216-N to determine a set of processing characteristics of the plurality of workloads for the first hardware device 216-1 and/or the second hardware device 216-N.

The first hardware device 216-1 can be further configured to generate a command containing information corresponding to the set of processing characteristics of the plurality of workloads processed by the first hardware device 216-1 and/or the second hardware device 216-N, and transfer the command containing the information corresponding to the set of processing characteristics of the plurality of workloads processed by the first hardware device 216-1 and/or the second hardware device 216-N to circuitry external to the first hardware device (e.g., to one or more of the processing units 210-1 to 210-N). In some embodiments, the first hardware device 216-1 can be configured to receive a command to allocate a workload to the first hardware device 216-1 and/or the second hardware device 216-N and allocate the workload to the first hardware device 216-1 and/or the second hardware device 216-N based, at least in part, on the received command. The received command can be self-generated by the first hardware device 216-1, or the received command can be generated by one of the processing units 210-1 to 210-N and sent by one of the processing units 210-1 to 210-N to the first hardware device 216-1.

That is, in some embodiments, the hardware devices 216-1 to 216-N can be provisioned with sufficient processing resources that they can monitor processing characteristics associated with execution of workloads they are executing. In addition, in some embodiments, the hardware devices 216-1 to 216-N can be provided with visibility therebetween such that the hardware devices 216-1 to 216-N can be aware of the processing characteristics of other hardware devices 216-1 to 216-N. Using these capabilities, the hardware devices 216-1 to 216-N can re-allocate workloads amongst one another based on monitored processing characteristics of the hardware devices 216-1 to 216-N and/or types of workloads allocated to the hardware devices 216-1 to 216-N.

In some embodiments, the allocated workload can be a workload executed subsequent to the plurality of workloads. For example, the first hardware device 216-1 can determine characteristics of its own processing performance in executing a workload and can cause a subsequent workload that is similar in scope to a previously executed workload to be allocated to the first hardware device 216-1 and/or the second hardware device 216-N. In addition, the first hardware device 216-1 can be configured to receive the command to allocate the workload executed subsequent to the plurality of workloads and allocate the workload executed subsequent to the plurality of workloads to the first hardware device 216-1 and/or the second hardware device based, at least in part, on the received command.

In some embodiments, the allocated workload can be processed by the first hardware device 216-1 and/or the second hardware device 216-N as part of a test operation conducted using the first hardware device 216-1 and/or the second hardware device 216-N. For example, as described above, the allocated workloads can be processed by the first hardware device 216-1 and/or the second hardware device 216-N in a testing scenario in which the computing system 200 is configured to test characteristics of different hardware devices 216-1 to 216-N to generate optimizations for the hardware devices 216-1 to 216-N once the hardware devices 216-1 to 216-N are deployed during runtime of the computing system 200.

Continuing with this non-limiting example, the circuitry external (e.g., the processing units 210-1 to 210-N) to the first hardware device 216-1 can be configured to divide the workload into at least two sub-workloads, allocate a first sub-workload to the first hardware device, allocate a second sub-workload to the second hardware device, and cause the first hardware device and the second hardware device to process the first and second sub-workloads substantially concurrently.

As used herein, the term “substantially” intends that the characteristic needs not be absolute, but is close enough so as to achieve the advantages of the characteristic. For example, “substantially concurrently” is not limited to operations that are performed absolutely concurrently and can include timings that are intended to be concurrent but due to manufacturing limitations may not be precisely concurrently. For example, due to read/write delays that may be exhibited by various interfaces (e.g., DDR vs PCIe) a first and second sub-workload that are performed “substantially concurrently” may not start or finish at exactly the same time. For example, the first and second sub-workloads may be performed such they are being performed at the same time regardless if one of the first and second sub-workloads commences or terminates prior to the other.

In some embodiments, the first hardware device 216-1 can be configured to allocate a portion of the workload to the second hardware device 216-N. For example, if the workload is allocated to the first hardware device 216-1, the first hardware device 216-1 can be configured to determine that processing the workload will consume greater than a threshold amount of processing resources, and/or will take longer than a threshold time period to complete, and re-allocate the workload to the second hardware device 216-N in response to the determination.

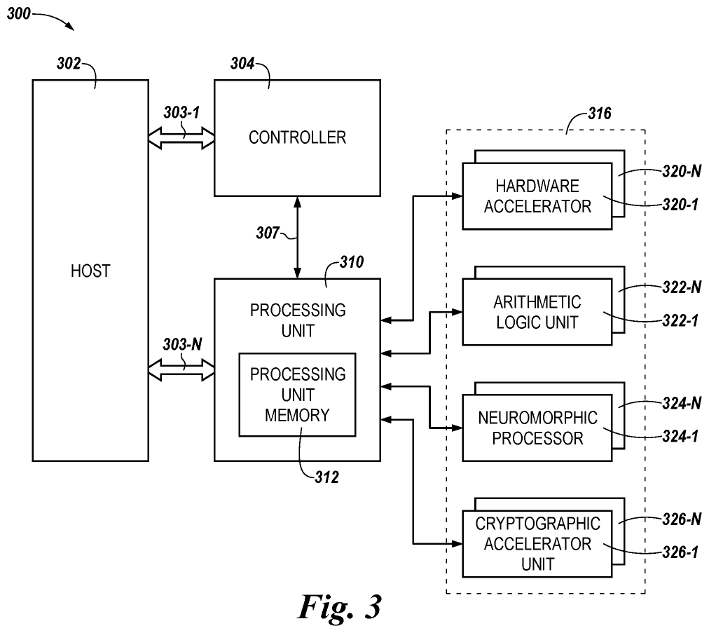

FIG. 3 is a functional block diagram in the form of a computing system 300 including a processing unit 310, a controller 304, and hardware devices 316 in accordance with a number of embodiments of the present disclosure. The hardware devices 316 can include hardware accelerators 320-1 to 320-N, arithmetic logic units 322-1 to 322-N, neuromorphic processors 324-1 to 324-N, and/or cryptographic accelerator units 326-1 to 326-N. As shown in FIG. 3, the processing unit 310 can include a processing unit memory (e.g., a “PROC. UNIT MEMORY) 312. The processing unit memory 312 can, in some embodiments, be a memory resource such as random-access memory (e.g., RAM, SRAM, etc.). Embodiments are not so limited, however, and the processing unit memory 312 can include various registers, caches, buffers, and/or memory arrays (e.g., 1T1C, 2T2C, 3T, etc. DRAM arrays). For example, the processing unit memory 312 can include volatile memory resource, non-volatile memory resources, or a combination of volatile and non-volatile memory resources. In some embodiments, the processing unit memory 312 can be a cache, one or more registers, NVRAM, ReRAM, FeRAM, MRAM, PCM), a resistance variable memory device such as 3-D Crosspoint memory devices, etc., or combinations thereof.

The processing unit memory 312 can be partitioned into one or more addressable memory regions. For example, the processing unit memory 312 can be partitioned into addressable memory regions so that various types of data can be stored therein. For example, one or more memory regions can store instructions used by the processing unit 310 and/or commands used by the processing unit 310. In some embodiments, the processing unit memory 312 can be used to store information corresponding to monitored characteristics of the hardware devices 316 as part of performance of an operation to selectively allocate workloads amongst components of the computing system 300 performed by the processing unit 310.

The processing unit 310 can be coupled to one or more hardware devices 316, such as the hardware accelerators 320-1 to 320-N, the arithmetic logic units 322-1 to 322-N, the neuromorphic processors 324-1 to 324-N, and/or the cryptographic accelerator units 326-1 to 326-N. Some examples of the hardware accelerators 320-1 to 320-N include sounds processing units (e.g., sound cards), graphics processing units (GPUs or “graphics cards”), digital signal processing units, analog signal processing units, computer networking processing units (e.g., networks on a chip, TCP offload engines, I/O acceleration processing units, etc.). artificial intelligence processing units (e.g., vision processing units, neural network processing units, etc.), tensor processing units, physics processing units, regular expression processing units, and/or data compression acceleration units, among others. The hardware accelerators 320-1 to 320-N can be provided as computer hardware in the form of a field-programmable gate array (FPGA), an application-specific integrated circuit (ASIC), and/or a complex programmable logic device, a system-on-chip, among others. It will be appreciated that the foregoing enumerated examples of hardware accelerators and specifically enumerated examples of computer hardware are neither limiting nor exhaustive, and other hardware accelerators and/or computer hardware are contemplated within the scope of the disclosure.

The arithmetic logic units (ALU) 322-1 to 322-N can include a combinational digital electronic circuit that can perform operations such as arithmetic operations, logical operations, bitwise operations, etc. on data stored by the memory device(s). In some embodiments, the ALU can be configured to perform such operations in response to receipt of signaling and/or commands generated by the processing unit 310, the controller 304, the host 302, and/or memory devices that can be coupled to the computing system 300.

The neuromorphic processors 324-1 to 324-N can be hardware devices configured to mimic neuro-biological architectures present in the nervous system. In some embodiments, the neuromorphic processors 324-1 to 324-N can be configured to perform machine learning algorithms in a manner such that the neuromorphic processors 324-1 to 324-N can be trained to perform operations based on previously learned scenarios, patterns, or other learnable criteria.

The cryptography accelerator units 326-1 to 326-N can be hardware devices configured to provide hardware-based encryption and/or decryption. In some embodiments, the cryptographic accelerator units 326-1 to 326-N can be configured to perform functions such as accelerating encryption algorithms, enhanced tamper, and intrusion detection, enhanced data, key protection and security enhanced memory access and I/O.

As described above, the processing unit 310 can receive signaling and/or commands that be indicative of workload characteristics of the hardware accelerators 320-1 to 320-N, the arithmetic logic units 322-1 to 322-N, the neuromorphic processors 324-1 to 324-N, and/or the cryptographic accelerator units 326-1 to 326-N. For example, the processing unit can receive signaling and/or commands indicative of an efficacy of at least one of the hardware accelerators 320-1 to 320-N, the arithmetic logic units 322-1 to 322-N, the neuromorphic processors 324-1 to 324-N, and/or the cryptographic accelerator units 326-1 to 326-N with respect to performing a particular task or operation.

The signaling and/or commands can be indicative of workload characteristics of different hardware devices in comparison to one another or the signaling and/or commands can be indicative of workload characteristics of different hardware devices that are of a same type in comparison to one another. For example, the signaling and/or commands can be indicative of workload characteristics of the hardware accelerators 320-1 to 320-N in performing a particular task or function in comparison to workload characteristics of the arithmetic logic units 322-1 to 322-N in performing the same particular task or function, or the signaling and/or commands can be indicative of workload characteristics of a first hardware accelerator 320-1 in performing a particular task or function in comparison to workload characteristics of a second hardware accelerator 320-N in performing the same particular task or function.

If the signaling and/or the command in indicative of a “test” or “testing” mode of operation, the processing unit 310 and/or a memory device can be operated to perform testing operations on various hardware components associated with the computing system 300. For example, the processing unit 310 and/or the memory device can be operated to test various performance attributes and/or operating characteristics of the hardware accelerators 320-1 to 320-N, the arithmetic logic units 322-1 to 322-N, the neuromorphic processors 324-1 to 324-N, and/or the cryptographic accelerator units 326-1 to 326-N. The testing can include testing different hardware components (e.g., different hardware accelerators 320-1 to 320-N, different arithmetic logic units 322-1 to 322-N, different neuromorphic processors 324-1 to 324-N, and/or different cryptographic accelerator units 326-1 to 326-N, etc.) under similar computing system performance characteristics to determine whether particular hardware components are better suited to certain tasks than other hardware components.

In a non-limiting example, the processing unit 310 can receive signaling and/or a command indicative of operating a memory device in a “test” or “testing” mode of operation. In response, the processing unit 310 and/or the memory device can enter the “test” or “testing” mode of operation and begin performing one or more tests using the hardware devices 316 (e.g., the hardware accelerators 320-1 to 320-N, the arithmetic logic units 322-1 to 322-N, the neuromorphic processors 324-1 to 324-N, and/or the cryptographic accelerator units 326-1 to 326-N). For simplicity, an example in which there are multiple hardware accelerators 320-1 to 320-N follows, however, it will be appreciated that similar techniques could be applied to the other hardware components (e.g., the arithmetic logic units 322-1 to 322-N, the neuromorphic processors 324-1 to 324-N, and/or the cryptographic accelerator units 326-1 to 326-N) as part of performing a testing operation using the example system 300 shown in FIG. 3.

Continuing with this example, the processing unit 310 can monitor the hardware accelerators 320 during performance of tasks performed by the hardware accelerators 320 to determine which hardware accelerators 320 perform certain tasks better or worse than other hardware accelerators 320. For example, a particular task may be assigned to each of the hardware accelerators 320 by the processing unit 310. The processing unit 310 can then monitor the speed, power consumption, accuracy, or other characteristics associated with the performance of the hardware accelerators 320 during performance of the task to determine which, if any, of the hardware accelerators 320 perform the task better than others (e.g., faster, with less power consumption, with a higher degree of accuracy, etc.).

The processing unit 310 can then cause information collected during the testing operation to be stored in the processing unit memory 312 for use during performance of the particular task at a later time. For example, if, after the task has been performed, the processing unit 310 determines that a first hardware accelerator performs the task more efficiently than a second hardware accelerator, the processing unit 310 can store information indicative of the increased performance by the first hardware accelerator in performing that particular task. Should the same (or a similar) task be called at a later time, the processing unit 310 can assign that task to the hardware accelerator 320-1 (e.g., the first hardware accelerator) based on the information stored in the processing unit memory 312.

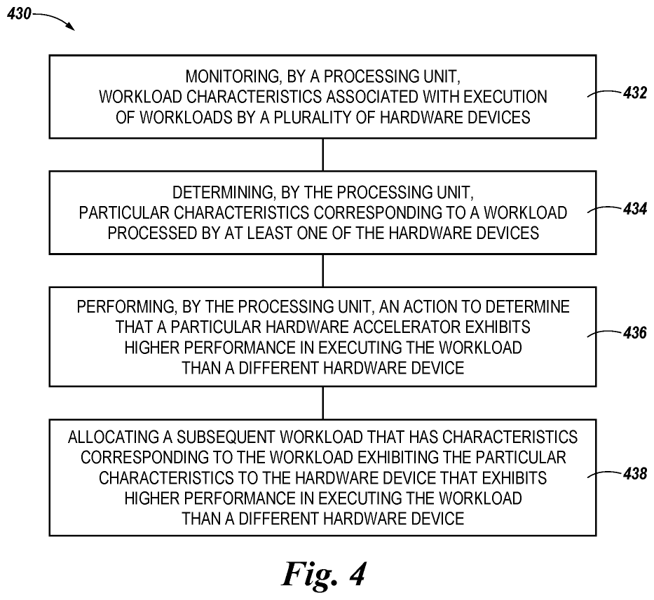

FIG. 4 is a flow diagram 430 representing an example method corresponding to a selectively operable memory device in accordance with a number of embodiments of the present disclosure. The method 430 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At block 432, the method 430 can include monitoring, by a processing unit, workload characteristics associated with execution of workloads by a plurality of hardware devices. The processing unit can be analogous to the processing unit 110 illustrated in FIG. 1 and the plurality of hardware devices can be analogous to the plurality of hardware devices 116-1 to 116-N illustrated in FIG. 1. For example, the hardware devices can include hardware accelerators, arithmetic logic units, neuromorphic processors, and/or cryptographic accelerators.

At block 434, the method 430 can include determining, by the processing unit, particular characteristics corresponding to a workload processed by at least one of the hardware devices. As described above, the characteristics can include characteristics indicative of an efficacy of the hardware devices in executing particular workloads. For example, the characteristics can include an amount of processing resources, an amount of time, an accuracy of a result, etc. of the executed workloads as performed by different hardware devices in a computing system.

At block 436, the method 430 can include performing, by the processing unit, an action to determine that a particular hardware device exhibits higher performance in executing the workload than a different hardware device. In some embodiments, the method 430 can include performing the action to determine that the particular hardware device exhibits the higher performance by processing, by the processing unit, information indicative of at least one processing characteristic corresponding to a workload processed by the at least one of the hardware devices. The action to determine that the particular hardware device exhibits higher performance can include identifying at least one of a number of operations, a processing speed, a throughput, an energy per bit, or any combination thereof, of the particular hardware device relative to another hardware device of the plurality.

At block 438, the method 430 can include allocating a subsequent workload that has characteristics corresponding to the workload exhibiting the particular characteristics to the hardware device that exhibits higher performance in executing the workload than a different hardware device. In some embodiments, the method 430 can include allocating, by the processing unit, the subsequent workload to the hardware device that exhibits the higher performance in executing the workload. In addition, the method 430 can, in some embodiments, include allocating, by the processing unit, the subsequent workload to the hardware device that exhibits the higher performance in executing the workload and at least one other hardware device. Embodiments are not so limited, however, and in some embodiments, the method 430 can include allocating, by the different hardware device, the subsequent workload to the hardware device that exhibits the higher performance in executing the workload based, at least in part, on receipt of a command to execute the subsequent workload generated by the processing unit.

The method 430 can further include generating, by the processing unit, a ranking for each of the plurality of hardware devices based on the particular characteristics corresponding to the workload processed by the hardware devices and allocating the subsequent workload to the plurality of hardware devices based, at least in part, on the generated ranking. For example,

In some embodiments, the method 430 can include determining, by the processing unit that a highest ranked hardware device is unable to process the subsequent workload and allocating the subsequent workload to a second highest ranked hardware device based, at least in part, on the determination.

Although specific embodiments have been illustrated and described herein, those of ordinary skill in the art will appreciate that an arrangement calculated to achieve the same results can be substituted for the specific embodiments shown. This disclosure is intended to cover adaptations or variations of one or more embodiments of the present disclosure. It is to be understood that the above description has been made in an illustrative fashion, and not a restrictive one. Combination of the above embodiments, and other embodiments not specifically described herein will be apparent to those of skill in the art upon reviewing the above description. The scope of the one or more embodiments of the present disclosure includes other applications in which the above structures and processes are used. Therefore, the scope of one or more embodiments of the present disclosure should be determined with reference to the appended claims, along with the full range of equivalents to which such claims are entitled.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A method, comprising:
monitoring, by a processing unit, workload characteristics associated with execution of workloads by a plurality of hardware devices;
determining, by the processing unit, particular characteristics corresponding to a workload processed by at least one of the hardware devices;
performing, by the processing unit, an action to determine that a particular hardware device exhibits higher performance in executing the workload than a different hardware device; and
allocating a subsequent workload that has characteristics corresponding to the workload exhibiting the particular characteristics to the hardware device that exhibits higher performance in executing the workload than a different hardware device.

2. The method of claim 1, wherein the plurality of hardware devices comprises at least one of a hardware accelerator, an arithmetic logic unit, a neuromorphic processor, or a cryptographic accelerator, or any combination thereof, and wherein the action to determine that the particular hardware device exhibits higher performance comprises identifying at least one of a number of operations, a processing speed, a throughput, an energy per bit, or any combination thereof, of the particular hardware device relative to another hardware device of the plurality.

3. The method of claim 1, further comprising performing the action to determine that the particular hardware device exhibits the higher performance by processing, by the processing unit, information indicative of at least one processing characteristic corresponding to a workload processed by the at least one of the hardware devices.

4. The method of claim 1, wherein allocating the subsequent workload further comprises allocating, by the processing unit, the subsequent workload to the hardware device that exhibits the higher performance in executing the workload.

5. The method of claim 1, wherein allocating the subsequent workload further comprises allocating, by the different hardware device, the subsequent workload to the hardware device that exhibits the higher performance in executing the workload based, at least in part, on receipt of a command to execute the subsequent workload generated by the processing unit.

6. The method of claim 1, wherein allocating the subsequent workload further comprises allocating, by the processing unit, the subsequent workload to the hardware device that exhibits the higher performance in executing the workload and at least one other hardware device.

7. The method of claim 1, further comprising:
generating, by the processing unit, a ranking for each of the plurality of hardware devices based on the particular characteristics corresponding to the workload processed by the hardware devices; and
allocating the subsequent workload to the plurality of hardware devices based, at least in part, on the generated ranking.

8. The method of claim 7, further comprising:
determining, by the processing unit that a highest ranked hardware device is unable to process the subsequent workload; and
allocating the subsequent workload to a second highest ranked hardware device based, at least in part, on the determination.

9. An apparatus, comprising:
a processing unit coupleable to a plurality of hardware devices, wherein the processing unit configured to:
receive information indicative of at least one processing characteristic of one or more of the plurality of hardware devices;
process the information indicative of the at least one processing characteristic to determine a performance characteristic of the one or more hardware devices; and
allocate a workload to the one or more hardware devices based, at least in part, on the determined performance characteristic of the one or more hardware devices.

10. The apparatus of claim 9, wherein the processing unit is further configured to:
generate a ranking of the plurality of hardware devices based on the determined performance characteristic of the one or more hardware devices; and
allocate the workload to the one or more hardware devices based, at least in part, on the generated ranking of the plurality of hardware devices.

11. The apparatus of claim 9, wherein the at least one processing characteristic includes information corresponding to a processing performance exhibited by the one or more of the plurality of hardware device components in processing a particular type of workload.

12. The apparatus of claim 9, wherein the processing unit is configured to send a command generated based on the determined performance characteristic of the one or more hardware devices to cause the one or more hardware devices to distribute the allocated workload amongst the one or more devices.

13. The apparatus of claim 9, wherein the one or more hardware devices to which the workload is allocated is configured to allocate a portion of the workload to a hardware device that is different than the one or more hardware devices to which the workload is allocated.

14. The apparatus of claim 9, wherein the workload is performed as part of a machine learning operation.

15. The apparatus of claim 9, wherein the processing unit is configured to:
determine that a subsequent workload that is different in scope than the workload allocated to the one or more hardware devices is to be executed; and
allocate the subsequent workload to a different one of the one or more hardware devices based, at least in part, on the determined performance characteristic of the different one of the one or more hardware devices.

16. The apparatus of claim 9, wherein the one or more hardware devices comprises at least one of a hardware accelerator, arithmetic logic units, neuromorphic processor, or cryptographic accelerator, or any combination thereof.

17. A system, comprising:
a first hardware device; and
a second hardware device communicatively coupled to the first hardware device, wherein the first hardware device is configured to:
analyze a plurality of workloads processed by the first hardware device or the second hardware device, or both, to determine a set of processing characteristics of the plurality of workloads for the first hardware device or the second hardware device, or both;
generate a command containing information corresponding to the set of processing characteristics of the plurality of workloads processed by the first hardware device or the second hardware device, or both;
transfer the command containing the information corresponding to the set of processing characteristics of the plurality of workloads processed by the first hardware device or the second hardware device, or both to circuitry external to the first hardware device;
receive a command to allocate a workload to the first hardware device or the second hardware device, or both; and
allocate the workload to the first hardware device or the second hardware device, or both based, at least in part, on the received command.

18. The system of claim 17, wherein the allocated workload is a workload executed subsequent to the plurality of workloads, and wherein the first hardware device is further configured to:
receive the command to allocate the workload executed subsequent to the plurality of workloads; and
allocate the workload executed subsequent to the plurality of workloads to the first hardware device or the second hardware device, or both based, at least in part, on the received command.

19. The system of claim 17, wherein the allocated workload is processed by the first hardware device or the second hardware device, or both, as part of a test operation conducted using the first hardware device or the second hardware device, or both.

20. The system of claim 17, wherein the circuitry external to the first hardware device is configured to:
divide the workload into at least two sub-workloads;
allocate a first sub-workload to the first hardware device;
allocate a second sub-workload to the second hardware device; and
cause the first hardware device and the second hardware device to process the first and second sub-workloads substantially concurrently.

21. The system of claim 17, wherein the first hardware device is configured to allocate a portion of the workload to the second hardware device.

22. The system of claim 17, wherein the workload is allocated to the first hardware device, and wherein the first hardware device is configured to:
determine that processing the workload will consume greater than a threshold amount of processing resources, will take longer than a threshold time period to complete, or both; and
re-allocate the workload to the second hardware device in response to the determination.
